(19) United States
(12) Patent Application Publication
(10) Pub. No.: US 2026/0181043 A1
(43) Pub. Date: Jun. 25, 2026

(54) METHOD AND DEVICE FOR STRUCTURED ENCODING AND ADDRESSING OF SYSTEM DATA

(71) Applicant: Yang WANG, Shanghai (CN)

(72) Inventor: Yang WANG, Shanghai (CN)

(21) Appl. No.: 19/540,641

(22) Filed: Feb. 14, 2026

(30) Foreign Application Priority Data
Jan. 7, 2026 (CN) 202610018771.6

(51) Int. Cl. H04L 67/1095; G06F 3/0482; G06F 16/22; G06F 16/248; G06F 16/84

(52) U.S. Cl. CPC H04L 67/1095; G06F 3/0482; G06F 16/2246; G06F 16/248; G06F 16/86

(57) ABSTRACT

A method for structured encoding and addressing of system data, including: constructing a structural addressing space having a plurality of hierarchical nodes arranged in multiple levels, each hierarchical node is assigned a unique code, the structural addressing space is configured to represent record objects of the system data, the unique code is configured to distinguish different parts, tissues, or record units; reading the unique code associated with a target record object of the record objects, and retrieving target system data of the target record object from the structural addressing space based on the unique code; extending the structural addressing space by adding a new subordinate node under a parent node according to new system data of the target record object, and assigning a new unique code to the new subordinate node; before the extending step, across system reference, or automated processing, predefined prerequisite confirmation conditions are satisfied.

### CROSS-REFERENCE TO RELATED APPLICATIONS

This application claims foreign priority of Chinese Patent Application No. 202610018771.6, filed on Jan. 7, 2026 in the China National Intellectual Property Administration, the disclosures of all of which are hereby incorporated by reference.

### TECHNICAL FIELD

The present disclosure relates to the technical field of systematic information data management, and in particular, to a method and a device for structured encoding and addressing of system data.

### BACKGROUND

With the continuous growth of modern systematic data, such data exhibits the characteristics of multiple sources, multiple formats, and cross-time periods. This phenomenon is particularly pronounced in the medical field, where massive amounts of medical diagnosis, treatment, follow-up, and other information are experiencing explosive growth. Moreover, these data originate from diverse sources, are recorded in non-uniform formats, and span significantly long time periods.

Existing medical information systems mainly rely on textual records, anatomical site descriptions, lesion characterizations, and manual data entry, and lack a unified structured encoding approach, resulting in the widespread presence of the following problems. The same anatomical site or tissue is recorded in inconsistent manners across different systems, making it difficult to establish data associations. Medical images, pathology data, examination results, and follow-up records are stored in a dispersed manner and lack structured referencing capability. Data sharing across different hospitals, different devices, and different time periods incurs high costs and is prone to semantic deviations. There is a lack of compatibility and extensibility to accommodate future newly added record items or further subdivided hierarchical levels for medical subjects. Electronic medical records, imaging systems, pathology systems, and the like each adopt independent naming conventions, lacking a unified addressing mechanism that supports retrieval and computation.

### SUMMARY

In order to overcome the deficiencies of the prior art, the present disclosure provides a method for structured encoding and addressing of system data, which is capable of improving data utilization efficiency and long-term management capability.

To realize the above objective, the present disclosure provides a method for structured encoding and addressing of system data, including: constructing a structural addressing space comprising a plurality of hierarchical nodes arranged in multiple levels, wherein each of the plurality of hierarchical nodes is assigned a unique code, and wherein the structural addressing space is configured to represent record objects of the system data, the unique code is configured to distinguish different parts, tissues, or record units; reading the unique code associated with a target record object of the record objects, and retrieving target system data of the target record object from the structural addressing space based on the unique code; extending the structural addressing space by adding a new subordinate node under a parent node in the hierarchical structure according to new system data of the target record object, and assigning a new unique code to the new subordinate node; before the extending step, across system reference, or automated processing, predefined prerequisite confirmation conditions are satisfied.

Furthermore, the system data comprises status records corresponding to the plurality of hierarchical nodes of the hierarchical structure, and the status records are stored in chronological order, thereby supporting sequential traceback or processing presentation of the status records related to the plurality of hierarchical nodes in the structural addressing space.

Furthermore, constructing a structural addressing space comprising a plurality of hierarchical nodes arranged in multiple levels includes: hierarchical division, dividing the record objects into multiple levels according to recording requirements of the system data, the structural addressing space is a tree-structural addressing space, the plurality of hierarchical nodes having parent-child hierarchical relationships.

Furthermore, assigning new unique code to the new subordinate node includes: generating a subsidiary code for the new subordinate node, the subsidiary code is combined with the unique code of all the parent nodes to form the new unique code of the new subordinate node.

Furthermore, the unique code of a current-level node of the plurality of hierarchical nodes is formed by sequentially combining the subsidiary code of the current-level node and subsidiary codes of all the parent nodes according to the parent-child hierarchical relationships.

Furthermore, the unique code is configured to be transferable across multiple systems and to maintain consistent referencing therein.

Furthermore, when the record units read or reference the unique code of each of the plurality of hierarchical nodes, the unique node is referenced and located, and corresponding system data is acquired.

Furthermore, a data timing of the unique code of each of the plurality of hierarchical nodes is synchronized through a timestamp.

Furthermore, new record dimensions are added to the unique code of each of the plurality of hierarchical nodes.

Constructing a structural addressing space including a plurality of hierarchical nodes arranged in multiple levels includes: determining a hierarchical framework, and establishing the multiple levels according to recording habits of the system data; defining nodes at each of the multiple levels, and establishing a mapping relationship between each of the plurality of hierarchical nodes of the multiple levels and the system data; establishing node association rules, so that each child node belongs only to the same parent node.

Reading the unique code associated with a target record object of the record objects, and retrieving target system data of the target record object from the structural addressing space based on the unique code includes: in response to an operation of a requesting terminal, acquiring an input unique code associated with the target record object that input from the requesting terminal; determining whether a target node corresponding to the input unique code exists if no, sending a prompt indicating that the input code does not exist to the requesting terminal; if yes, locating a target node according to the target code; associating with the data storage address and retrieving target data across systems according to the target node; sending the target system data to the requesting terminal.

Extending the structural addressing space by adding a new subordinate node under a parent node in the hierarchical structure according to new system data of the target record object, and assigning a new unique code to the new subordinate node includes: detecting new system data and triggering node extension; locating a position of the parent node, and according to attributes of the new system data, matching a most fitting node in the hierarchical structure as the parent node; assigning a new unique code to the new subordinate node; adding a new subordinate node under the parent node in the hierarchical structure, and associating the new system data with the new subordinate node.

The present disclosure further provides a device for structured encoding and addressing of the system data, comprising a memory, a processor, and a program for structured encoding and addressing of system data stored on the memory, wherein when the program for structured encoding and addressing of the system data is executed by the processor, the steps of the method mentioned above is implemented.

The beneficial effects of the present disclosure are as follows: improving the hierarchical management clarity of medical data; supporting cross-system and cross-time-period referencing of medical data; reducing information misinterpretation and recording deviations; enhancing the extensibility and long-term compatibility of medical data structures; providing a unified addressing foundation for future medical data management tools.

### BRIEF DESCRIPTION OF DRAWINGS

In order to more clearly illustrate the technical solutions in the embodiments of the present disclosure, a brief introduction will be given below to the drawings required for describing the embodiments. The drawings described below are merely some embodiments of the present disclosure. For those of ordinary skill in the art, other drawings may also be obtained from these drawings without any creative effort.

The present disclosure will be further described below in conjunction with the accompanying drawings and specific embodiments.

FIG. 1 is a flowchart of a method for structured encoding and addressing of system data according to an embodiment of the present disclosure.

FIG. 2 is a first detailed flowchart of the method for structured encoding and addressing of system data according to an embodiment of the present disclosure.

FIG. 3 is a second detailed flowchart of the method for structured encoding and addressing of system data according to an embodiment of the present disclosure.

FIG. 4 is a third detailed flowchart of the method for structured encoding and addressing of system data according to an embodiment of the present disclosure.

FIG. 5 is a schematic diagram of a hardware structure of a device for structured encoding and addressing of the system data according to an embodiment of the present disclosure.

### DETAILED DESCRIPTION OF THE EMBODIMENTS

The following describes in detail the embodiments of the present disclosure, and examples of the embodiments are shown in the accompanying drawings.

In the description of this specification, reference to the terms “certain embodiments,” “one embodiment,” “some embodiments,” “exemplary embodiment,” “example,” “specific example,” or “some examples” means that a particular feature, structure, material, or characteristic described in connection with the embodiment or example is included in embodiment or example of the present disclosure. In this specification, the schematic representations of the above terms do not necessarily refer to the same embodiment or example. Moreover, the specific features, structures, materials, or characteristics described may be combined in any suitable manner in one or more embodiments or examples.

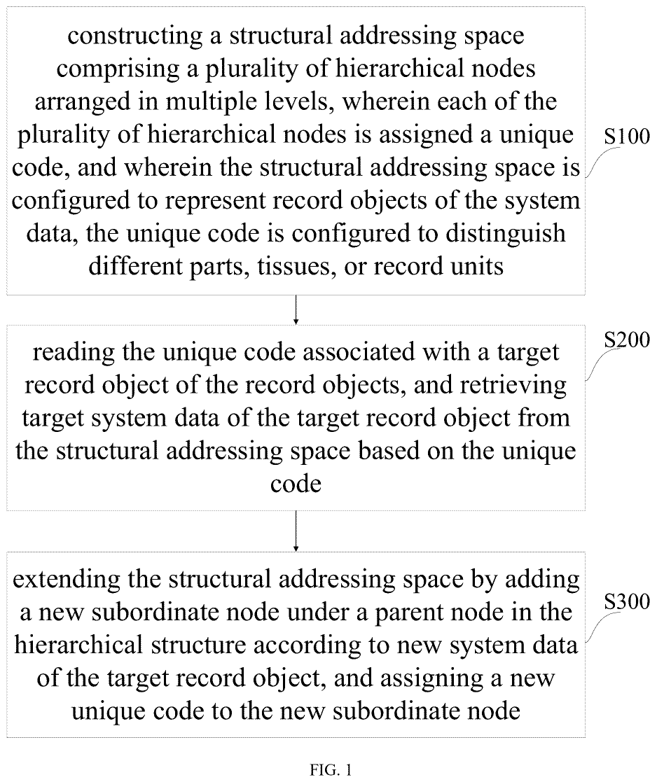

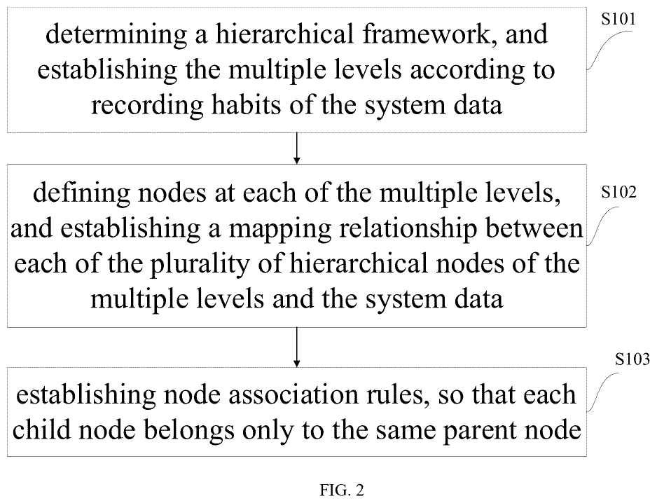

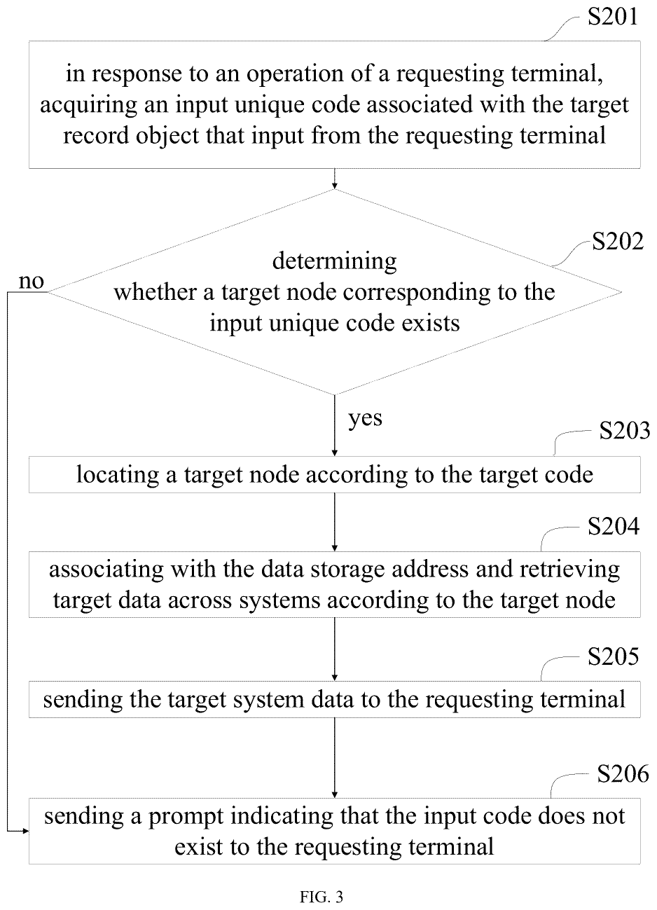

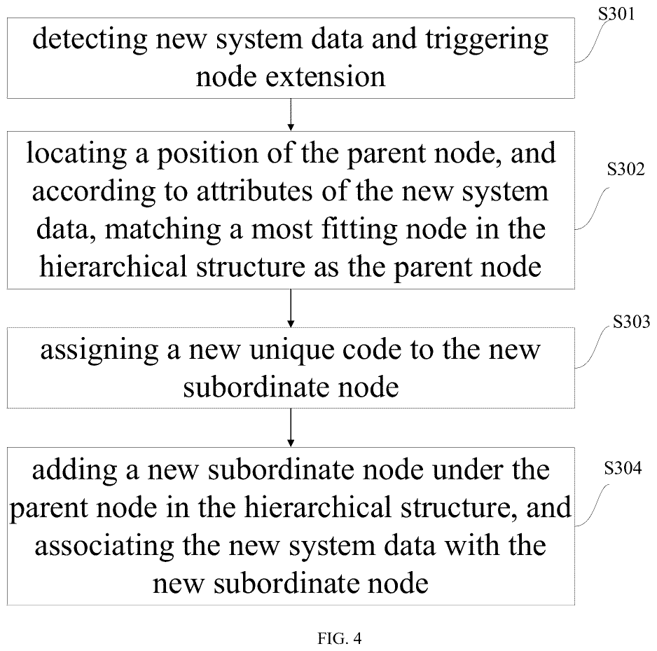

Referring to FIGS. 1-4, a method for structured encoding and addressing of system data includes the following steps of S100 to S300.

S100: constructing a structural addressing space including a plurality of hierarchical nodes arranged in multiple levels, wherein each of the plurality of hierarchical nodes is assigned a unique code, and wherein the structural addressing space is configured to represent record objects of the system data, the unique code is configured to distinguish different parts, tissues, or record units.

The specific execution process of S100 includes the following S101 to S103.

S101: determining a hierarchical framework, and establishing the multiple levels according to recording habits of the system data.

For example, when the system data is human medical data, multiple levels may be established by combining human physiological structure and the recording habits of medical data. Specifically, core level may be established, including the following nodes.
\textcircled{1} A root node, which is a unique top-level node and generally can represent the entirety of human medical data.
\textcircled{2} System-level nodes, which are specific physiological systems of the human body, such as respiratory system, digestive system, urinary system, etc., corresponding to major categories of medical data recording fields.
\textcircled{3} Region-level nodes, which are body parts/tissues corresponding to specific physiological systems of the human body, such as lungs, trachea, etc. under the respiratory system, corresponding to specific medical object regions.
\textcircled{4} Record unit-level node, divided according to medical data types, including CT examination, pathological records, follow-up records, etc., corresponding to “specific data record types”.

S102: defining nodes at each of the multiple levels, and establishing a mapping relationship between each of the plurality of hierarchical nodes of the multiple levels and the system data.

For example, when the system data is human medical data, mapping relationships are established between specific human physiological systems, body parts/tissues corresponding to each physiological system, medical data types, and other contents and the nodes at each of the multiple levels, so that each level's nodes correspond one-to-one with the system data;

In one embodiment, the root node is represented by 01 for the entirety of patient Zhao's human medical data, the system-level node is represented by 01 for the respiratory system, the region-level node is represented by 03 for the lungs, and the record unit-level node is represented by 01 for computed tomography (CT) examination, then the complete unique code is Jan. 1, 2003-01, establishing a unique correspondence between the system data and code. According to this unique code, the information that can be obtained is the lung CT examination result of patient Zhao.

S103: establishing node association rules, so that each child node belongs only to the same parent node.

Each parent node corresponds to multiple child nodes, and each child node belongs only to the same parent node. Parent and child nodes are bound to ensure that each code corresponds to exactly one unique node, preventing confusion when referencing node-corresponding data according to the code.

S200: reading the unique code associated with a target record object of the record objects, and retrieving target system data of the target record object from the structural addressing space based on the unique code.

The specific execution process of S200 includes the following S201 to S204.

S201: in response to an operation of a requesting terminal, acquiring an input unique code associated with the target record object that input from the requesting terminal.

S202: determining whether a target node corresponding to the input unique code exists; if yes, execute S203; if no, execute S206.

S203: locating a target node according to the target code.

S204: associating with the data storage address and retrieving target data across systems according to the target node.

S205: sending the target system data to the requesting terminal.

S206: sending a prompt indicating that the input code does not exist to the requesting terminal.

For example, when the system data is human medical data, a doctor can input the unique code 01-01-03-01 on the requesting terminal, such as a computer or other terminal. Obtains the unique code, locates a target node according to the unique code, retrieves data cross-system from the data storage address corresponding to the input unique node, and returns the lung CT examination result of patient Zhao to the requesting terminal (the doctor's computer). Through the above steps, cross-system encoding and data transmission can be achieved while maintaining consistent referencing. Moreover, if the input unique code does not correspond to an existing node, sending a “code does not exist” prompt message to the requesting terminal.

S300: extending the structural addressing space by adding a new subordinate node under a parent node in the hierarchical structure according to new system data of the target record object, and assigning a new unique code to the new subordinate node.

The specific execution process of S300 includes the following S301 to S304.

S301: detecting new system data and triggering node extension.

S302: locating a position of the parent node, and according to attributes of the new system data, matching a most fitting node in the hierarchical structure as the parent node.

S303: assigning a new unique code to the new subordinate node.

S304: adding a new subordinate node under the parent node in the hierarchical structure, and associating the new system data with the new subordinate node.

When the new system data belongs to a lower-level subdivision item of an existing parent node or newly added subdivision data within an existing dimension, node extension is triggered. Still taking human medical data as an example.

Example 1: Patient Zhao underwent a lung magnetic resonance imaging (MRI) examination. New system data is detected as lung MRI examination, triggering node extension. It belongs to a lower-level subdivision item of the existing node—lungs. Thus, the existing node—lungs—serves as the parent node. According to the encoding rules, a unique code 01-01-03-04 is assigned to the newly added node (lung MRI examination). It should be noted that the new subordinate code must not overlap with existing codes, ensuring unique correspondence of system data. Configuring the newly added subordinate node and associates this data with the node, facilitating subsequent location of the node through the code to obtain the corresponding data.

Example 2: Patient Zhao underwent low-dose lung CT screening. Low-dose lung CT screening belongs to a lower-level subdivision item of the existing node—lung CT examination, triggering node extension. The existing node—lung CT examination—serves as the parent node. According to the encoding rules, a unique code 01-01-03-01-01 is assigned to the newly added node (low-dose lung CT screening). Configuring the newly added node and associates this data with the node, facilitating subsequent location of the node through the code to obtain the corresponding data.

Through S300, new system dimensions can be added, supporting infinite hierarchical extension to include data types not present in existing medical systems. As long as future possible new data is categorized into the existing system framework according to the encoding rules, subsequent expansion becomes convenient. It is applicable to newly added recording dimensions in the future. Moreover, new system data has its own dedicated storage node and will not compete with or crowd out old nodes. This allows new system data storage requirements to be met while keeping the original hierarchical structure stable, and also enables finer data classification, improving the precision of data retrieval through unique codes.

Before the extending step, across system reference, or automated processing, predefined prerequisite confirmation conditions are satisfied.

In the medical field, the preset predefined conditions are generally designed around medical data security, encoding uniqueness, operational compliance, and cross-system compatibility, to avoid node confusion, data leakage, or cross-system conflicts, and to meet the rigorous requirements of medical scenarios.

For example, in S301, after new system data is detected and node extension is triggered, it is necessary to determine whether the predefined prerequisite confirmation conditions are met—generally whether the data submitter has permission to extend nodes and whether the new system data complies with the original rules. When the result is yes, the subsequent node extension S302-S304 are executed.

For example, in S201, in response to an operation performed by the requesting terminal, after acquiring the inputted unique code, it is necessary to determine whether predefined prerequisite confirmation conditions are satisfied-typically including whether the requesting terminal possesses citation authority and whether patient authorization has been obtained. Only when the determination results are all affirmative, the subsequent cross-system citation S202-S206 are executed.

In this embodiment, the system data includes status records corresponding to the plurality of hierarchical nodes of the hierarchical structure, and the status records are stored in chronological order, thereby supporting sequential traceback or processing presentation of the status records related to the plurality of hierarchical nodes in the structural addressing space. In this embodiment (taking the status temporal backtracking embodiment related to human body structure as an example), a human lung-related medical data management scenario is still used as an illustration. By relying on a pre-defined static human body structure tree (i.e., the structural addressing space), status records generated after clinical diagnosis/treatment are bound to corresponding structural nodes and stored in chronological order, thereby realizing temporal backtracking and complete process reproduction of lung-related medical procedures.

For instance, in the foregoing embodiment, the unique code 01-01-03-01 is used to correspond to a lung CT examination of patient Zhao. Correspondingly, after completing diagnosis, treatment or follow-up, the attending physician confirms and enters the status record into the system based on actual clinical findings, and binds this status record to the structural node corresponding to the unique code 01-01-03-01. The status record includes the node code, status description, confirmation information, and timestamp. Thus, the corresponding status record for patient Zhao's lung CT examination may be expressed as: “01-01-03-01—Ground-glass nodule in right upper lobe of lung, size 5 mm×4 mm, uniform density, benign tendency—physician Li (radiology department)—2021 Sep. 18 07:30”.

When it is necessary to perform backtracking or retrieval of the corresponding record, the relevant unique code can be directly inputted into the system, whereupon all status descriptions and confirmation information associated with that node are retrieved and presented in chronological order. For example, upon inputting the unique code 01-01-03-01, all lung CT examination records of patient Zhao can be queried. By selecting the record dated 2021 Sep. 18 07:30, detailed information such as “Ground-glass nodule in right upper lobe of lung, size 5 mm×4 mm, uniform density, benign tendency, confirmed by physician Li (radiology department)” can be obtained, and the CT images stored under the corresponding node can optionally be retrieved.

According to the above method, bidirectional mapping between a timeline and the structure tree can be realized. This enables both chronological presentation of the diagnosis and treatment process and tracking of disease progression according to specific anatomical sites or nodes, thereby facilitating physicians' understanding of the patient's condition evolution. Furthermore, by virtue of the bound unique codes and corresponding nodes, system data can be invoked and cited across different systems, which greatly simplifies physician operations, enables rapid information retrieval, and provides reliable support for subsequent diagnosis and treatment decisions.

In this embodiment, the addressing space is a tree-structural addressing space, and the plurality of hierarchical nodes having parent-child hierarchical relationships.

In this embodiment, the step of “assigning a new unique code to the new subordinate node” includes: generating a subsidiary code for the new subordinate node, the subsidiary code is combined with the unique code of all the parent nodes to form the new unique code of the new subordinate node.

In this embodiment, the unique code of a current-level node is formed by sequentially concatenating the appended code of the current-level node and the appended codes of all superior nodes in accordance with the parent-child hierarchical relationship among the respective nodes.

In this embodiment, the unique code is configured to be transferable across multiple systems and to maintain consistent referencing therein.

In this embodiment, when the record units read or reference the unique code of each of the plurality of hierarchical nodes, the unique node is referenced and located, and corresponding system data is acquired.

In this embodiment, a data timing of the unique code of each of the plurality of hierarchical nodes is synchronized through a timestamp.

In this embodiment, new record dimensions are added to the unique code of each of the plurality of hierarchical nodes.

The advantageous effects of the present disclosure include: improving the clarity of hierarchical management of medical data; supporting cross-system and cross-time-period citation of medical data; reducing information misinterpretation and record deviation; enhancing the scalability and long-term compatibility of medical data structures; and providing a unified addressing foundation for future medical data management tools.

The embodiments of the present disclosure further disclose a device for structured encoding and addressing of the system data, including a memory, a processor, and a program for structured encoding and addressing of system data stored on the memory, wherein when the program for structured encoding and addressing of the system data is executed by the processor, the steps of the method mentioned above is implemented.

In the embodiments of the present disclosure, a device for structured encoding and addressing of the system data primarily relates to a network-connectable device, and the device for structured encoding and addressing of the system data may be a server, a cloud platform, or the like.

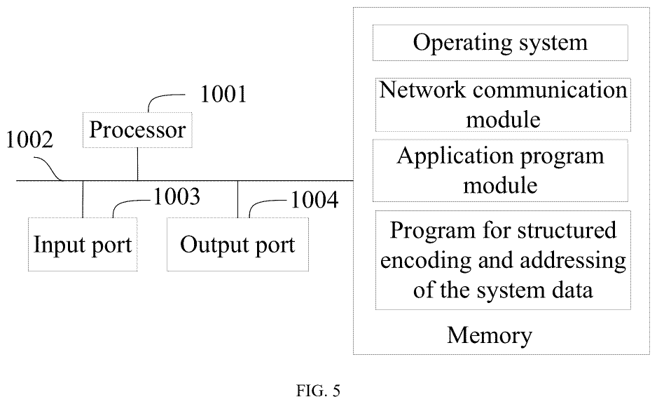

Referring to FIG. 5, FIG. 5 is a schematic diagram illustrating an exemplary hardware structure of the device for structured encoding and addressing of the system data according to various embodiments of the present disclosure. In the embodiments of the present disclosure, the device for structured encoding and addressing of the system data may include a processor 1001 (such as a Central Processing Unit (CPU)), a communication bus 1002, an input port 1003, an output port 1004, and a memory 1005. The communication bus 1002 is configured to enable connection and communication among these components; the input port 1003 is configured for data input; the output port 1004 is configured for data output; and the memory 1005 may be a high-speed RAM memory or a stable non-volatile memory (such as a disk memory). Optionally, the memory 1005 may further be a storage device independent of the aforementioned processor 1001. Those skilled in the art will appreciate that the hardware structure shown in FIG. 5 does not constitute a limitation on the present disclosure and may include more or fewer components than those illustrated, or certain components may be combined, or the components may be arranged differently.

Continuing to refer to FIG. 5, the memory 1005, as one form of readable storage medium, may include an operating system, a network communication module, an application program module, and the program for structured encoding and addressing of the system data. In FIG. 5, the network communication module is primarily used to connect to a server and perform data communication with the server; the processor 1001 is configured to invoke the program for structured encoding and addressing of the system data stored in the memory 1005 and to execute the steps of the aforementioned method for structured encoding and addressing of the system data

Although the embodiments of the present disclosure have been shown and described above, it should be understood that the above embodiments are exemplary only and are not to be construed as limiting the present disclosure. A person of ordinary skill in the art may make changes, modifications, substitutions and variations to the above embodiments within the scope of the present disclosure. The above embodiments are merely illustrative examples of the present disclosure and do not limit the protection scope of the present disclosure. Any equivalent modifications or substitutions made by those skilled in the art without departing from the inventive concept of the present disclosure shall fall within the protection scope of the present disclosure.

What is claimed is:

1. A method for structured encoding and addressing of system data, comprising:
constructing a structural addressing space comprising a plurality of hierarchical nodes arranged in multiple levels, wherein each of the plurality of hierarchical nodes is assigned a unique code, and wherein the structural addressing space is configured to represent record objects of the system data, the unique code is configured to distinguish different parts, tissues, or record units;
reading the unique code associated with a target record object of the record objects, and retrieving target system data of the target record object from the structural addressing space based on the unique code;
extending the structural addressing space by adding a new subordinate node under a parent node in the hierarchical structure according to new system data of the target record object, and assigning a new unique code to the new subordinate node;
wherein, before the extending step, across system reference, or automated processing, predefined prerequisite confirmation conditions are satisfied;
wherein the determination result represents a system-level runtime eligibility qualification, rather than an automatic execution, control, or actuation of any physical process or device.

2. The method according to claim 1, wherein the system data comprises status records corresponding to the plurality of hierarchical nodes of the hierarchical structure, and the status records are stored in chronological order, thereby supporting sequential traceback or processing presentation of the status records related to the plurality of hierarchical nodes in the structural addressing space.

3. The method according to claim 1, wherein constructing a structural addressing space comprising a plurality of hierarchical nodes arranged in multiple levels comprises:
hierarchical division, dividing the record objects into multiple levels according to recording requirements of the system data, wherein the structural addressing space is a tree-structural addressing space, the plurality of hierarchical nodes having parent-child hierarchical relationships.

4. The method according to claim 3, wherein assigning new unique code to the new subordinate node comprises:
generating a subsidiary code for the new subordinate node, the subsidiary code is combined with the unique code of all the parent nodes to form the new unique code of the new subordinate node.

5. The method according to claim 4, wherein the unique code of a current-level node of the plurality of hierarchical nodes is formed by sequentially combining the subsidiary code of the current-level node and subsidiary codes of all the parent nodes according to the parent-child hierarchical relationships.

6. The method according to claim 1, wherein the unique code is configured to be transferable across multiple systems and to maintain consistent referencing therein.

7. The method according to claim 1, wherein when the record units read or reference the unique code of each of the plurality of hierarchical nodes, the unique node is referenced and located, and corresponding system data is acquired.

8. The method according to claim 1, wherein a data timing of the unique code of each of the plurality of hierarchical nodes is synchronized through a timestamp.

9. The method according to claim 1, wherein new record dimensions are added to the unique code of each of the plurality of hierarchical nodes.

10. A device for structured encoding and addressing of system data, comprising a memory, a processor, and a program for performing structured encoding and addressing of system data stored in the memory, wherein when the processor executes the structured encoding and addressing program, following steps are implemented:
constructing a structural addressing space comprising a plurality of hierarchical nodes arranged in multiple levels, wherein each of the plurality of hierarchical nodes is assigned a unique code, and wherein the structural addressing space is configured to represent record objects of the system data, the unique code is configured to distinguish different parts, tissues, or record units;
reading the unique code associated with a target record object of the record objects, and retrieving target system data of the target record object from the structural addressing space based on the unique code;
extending the structural addressing space by adding a new subordinate node under a parent node in the hierarchical structure according to new system data of the target record object, and assigning a new unique code to the new subordinate node;
wherein, before the extending step, across system reference, or automated processing, predefined prerequisite confirmation conditions are satisfied;
wherein the determination result represents a system-level runtime eligibility qualification, rather than an automatic execution, control, or actuation of any physical process or device.

11. The device according to claim 10, wherein the system data comprises status records corresponding to the plurality of hierarchical nodes of the hierarchical structure, and the status records are stored in chronological order, thereby supporting sequential traceback or processing presentation of the status records related to the plurality of hierarchical nodes in the structural addressing space.

12. The device according to claim 10, wherein constructing a structural addressing space comprising a plurality of hierarchical nodes arranged in multiple levels comprises:
hierarchical division, dividing the record objects into multiple levels according to recording requirements of the system data, wherein the structural addressing space is a tree-structural addressing space, the plurality of hierarchical nodes having parent-child hierarchical relationships.

13. The device according to claim 10, wherein assigning new unique code to the new subordinate node comprises:
generating a subsidiary code for the new subordinate node, the subsidiary code is combined with the unique code of all the parent nodes to form the new unique code of the new subordinate node.

14. The device according to claim 10, wherein the unique code of a current-level node of the plurality of hierarchical nodes is formed by sequentially combining the subsidiary code of the current-level node and subsidiary codes of all the parent nodes according to the parent-child hierarchical relationships.

15. The device according to claim 10, wherein the unique code is configured to be transferable across multiple systems and to maintain consistent referencing therein.

16. The device according to claim 10, wherein when the record units read or reference the unique code of each of the plurality of hierarchical nodes, the unique node is referenced and located, and corresponding system data is acquired.

17. The device according to claim 10, wherein a data timing of the unique code of each of the plurality of hierarchical nodes is synchronized through a timestamp.

18. The device according to claim 10, wherein new record dimensions are added to the unique code of each of the plurality of hierarchical nodes.
